(19) United States
(12) Patent Application Publication
(10) Pub. No.: US 2024/0372397 A1
(43) Pub. Date: Nov. 7, 2024

(54) DEVICE AND METHOD FOR CHARGING AN INTERMEDIATE CIRCUIT CAPACITOR, ENERGY SUPPLY NETWORK, AND ELECTRICAL DRIVE SYSTEM

(71) Applicant: Robert Bosch GmbH, Stuttgart (DE)

(72) Inventor: Falco Sengebusch, Stuttgart (DE)

(21) Appl. No.: 18/690,823

(22) PCT Filed: Jul. 25, 2022
(86) PCT No.: PCT/EP2022/070774

§ 371 Date: Mar. 11, 2024

(30) Foreign Application Priority Data
Sep. 24, 2021 (DE) 10 2021 210 686.2

(51) Int. Cl. H02J 7/34; B60L 50/40; B60L 50/60; B60L 58/12; B60L 58/20

(52) U.S. Cl. CPC H02J 7/345; B60L 50/40; B60L 50/66; B60L 58/12; B60L 58/20; B60L 2210/14; H02J 2207/50

(57) ABSTRACT

The invention relates to the charging of an intermediate circuit capacitor in a high-voltage network by means of electrical energy from a low-voltage network. According to the invention, it is provided that the power flow from the low-voltage network into the high-voltage network is adjusted using an operating parameter of the low-voltage network, such as electrical voltage in the low-voltage network.

### BACKGROUND

The present invention relates to a device and a method for charging an intermediate circuit capacitor, in particular an intermediate circuit capacitor in a high-voltage network. The present invention also relates to a power supply network and an electrical drive system for an electric vehicle.

Fully or at least partially electrically powered vehicles have an electrical drive system that is powered by a traction battery. The electrical drive system generally comprises an electric machine and a power converter, in particular an inverter, whereby what is referred to as an intermediate circuit capacitor is provided in the power converter to stabilize a DC input voltage. When switched off, the traction battery can be disconnected from the power converter of the electrical drive system by means of a circuit breaker. Before reconnecting the traction battery to the power converter, it is desirable to charge the intermediate circuit capacitor in the power converter to a voltage level that at least approximately corresponds to the voltage level of the traction battery. An electrical connection can then be established between the traction battery and the power converter via the circuit breaker.

For example, DE 10 2016 200 662 A1 describes a bidirectional DC/DC converter for charging an intermediate circuit capacitor from a low-voltage battery.

### SUMMARY

The present invention discloses a device and a method for charging an intermediate circuit capacitor in a high-voltage network, as well as a power supply network for an electric vehicle and an electrical drive system with the features of the disclosure.

Accordingly, the following is provided:
A device for charging an intermediate circuit capacitor in a high-voltage network. The device comprises a DC/DC converter and a control means. The DC/DC converter is designed to be coupled to a low-voltage network on one input side. The DC/DC converter is further designed to be coupled to the intermediate circuit capacitor at an output connection and to provide a charging voltage for charging the intermediate circuit capacitor. The control means is designed to determine an operating parameter of the low-voltage network. The control means is also designed to adjust a power flow from the low-voltage network to the intermediate circuit capacitor in the high-voltage network using the determined operating parameter.

The following are furthermore provided:
a power supply network for an electric vehicle with a high-voltage network, a low-voltage network, and a device according to the invention for charging an intermediate circuit capacitor. The high-voltage network comprises a high-voltage battery, an intermediate circuit capacitor and a circuit breaker. The circuit breaker is designed to open or close an electrical connection between the high-voltage battery and the intermediate circuit capacitor.

The following are furthermore provided:
an electrical drive system with a power supply network according to the invention, an electric machine, and an electric power converter. The power converter is designed to control the electrical machine using the electrical energy provided in the high-voltage network. The intermediate circuit capacitor of the high-voltage network can in this case be provided in the electrical power converter in particular.

Finally, the following is provided:
a method for charging an intermediate circuit capacitor in a high-voltage network. The method comprises a step for determining an operating parameter in a low-voltage network. The method further comprises a step for charging the intermediate circuit capacitor in the high-voltage network using electrical energy from the low-voltage network. The power flow from the low-voltage network to the intermediate circuit capacitor in the high-voltage network is in this case adjusted using the operating parameter determined for the low-voltage network.

The present invention is based on the realization that, when charging an intermediate circuit capacitor in a high-voltage network by means of electrical energy from a low-voltage network, this low-voltage network is usually supplied by a battery. The present invention is also based on the realization that such a battery has only a limited capacity in a low-voltage network. If the state of charge of the battery in the low-voltage network drops, voltage dips can occur in the low-voltage network with the battery when energy is drawn to charge the intermediate circuit capacitor in the high-voltage network.

Therefore, the idea behind the present invention is to take this realization into account and to control the power for charging the intermediate circuit capacitor in the high-voltage network such that a stable supply voltage can also be continuously maintained in the low-voltage network during charging. For this purpose, before and/or during the charging of the intermediate circuit capacitor, it is intended to evaluate one or multiple properties of the low-voltage network, in particular of the battery that feeds the low-voltage network, and to adjust the charging power for charging the intermediate circuit capacitor using these parameters such that no undesirable voltage dips occur in the low-voltage network.

The low-voltage network generally supplies numerous other electrical consumers in addition to the DC/DC converter for the electrical energy transfer between the high-voltage network and the low-voltage network. In particular, sensitive electrical components, e.g. control means or the like, can also be supplied with electrical energy from the low-voltage network. By adjusting the power flow from the low-voltage network to the high-voltage network during charging of the intermediate circuit capacitor, it is in this case possible to ensure that the energy drawn from the low-voltage network is always limited to values that do not lead to a significant voltage dip in the low-voltage network, which could lead to faults or malfunctions of the other consumers connected to the low-voltage network.

The intermediate circuit capacitor can be charged in this way, particularly if the state of charge of the battery in the low-voltage network is low and/or the batteries in the low-voltage network are very old, without causing faults or malfunctions of the other consumers in the low-voltage network.

According to one embodiment, the operating parameter comprises an electrical voltage in the low-voltage network. Accordingly, the control means is designed to determine an electrical voltage of the low-voltage network. The control means can further be designed to adjust the power flow from the low-voltage network to the intermediate circuit capacitor in the high-voltage network using the determined electrical voltage of the low-voltage network. In many cases, the electrical voltage of a battery, in this case the battery of the low-voltage network correlates with the state of charge of the battery. As the state of charge decreases, the electrical output voltage of the battery also decreases and with it the voltage in the low-voltage network. The power flow from the low-voltage network for charging the intermediate circuit capacitor into the high-voltage network can therefore be adjusted according to the electrical voltage in the low-voltage network. For example, a linear dependency between the electrical voltage in the low-voltage network and the power flow can be specified. In addition, the power flow can also be specified in multiple stages. For example, the power flow can be limited to a first value below a predefined threshold voltage, while a higher power flow is set above this threshold voltage. Of course, multiple stages are also possible for controlling the power flow. In addition, any other specifications for adapting the power flow depending on the electrical voltage in the low-voltage network are also possible.

According to one embodiment, the control means is designed to determine a status value of a battery connected to the low-voltage network. Accordingly, the control means can be designed to adjust the power flow from the low-voltage network to the intermediate circuit capacitor in the high-voltage network using the determined status value. This status value can be any value that specifies a characteristic value of the battery in the low-voltage network. For example, a battery management unit or similar can be used to determine a state of charge, a state of health or similar. In addition, the temperature of the battery in the low-voltage network can, e.g., also be taken into account. A battery can, e.g., thus only provide a lower maximum output at lower temperatures than is the case at higher temperatures.

According to one embodiment, the control means comprises a data interface. The data interface of the control means can be designed to receive the operating parameter of the low-voltage network, in particular the status value of the connected battery. For example, the corresponding data can be transmitted via a CAN bus or any other suitable data bus.

According to one embodiment, the control means is designed to deactivate at least one consumer connected to the low-voltage network depending on the operating parameter determined. In particular, one or multiple consumers in the low-voltage network can be deactivated while the intermediate circuit capacitor is charging. While the intermediate circuit capacitor is charging, less critical consumers such as seat heating, a fan or similar can, e.g., be deactivated or at least their output reduced. In this way, the battery in the low-voltage network is less heavily loaded during charging, so that more energy is available for charging the intermediate circuit capacitor. In particular, one or multiple consumers in the low-voltage network can be deactivated during charging of the intermediate circuit capacitor depending on the operating parameter determined as described above.

According to one embodiment, the device for charging an intermediate circuit capacitor comprises an output means. The output means can be designed to emit an optical and/or acoustic signal if a value of the determined operating parameter falls below a predefined threshold value. Alternatively, the determined operating parameter or the value of the determined operating parameter can be shown on a display. In this way, a user can be informed of a critical state in the low-voltage network, in particular the battery of the low-voltage network, at an early stage. A user can, e.g., arrange for the battery in the low-voltage network to be replaced in good time before the performance of the battery in the low-voltage network is further reduced and this can lead to faults or failures.

The above embodiments and developments can be combined with one another in any desired manner to the extent that doing so is advantageous. Further embodiments, developments, and implementations of the invention also comprise combinations not explicitly mentioned of features of the invention described above or below with respect to the exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic representation of a block diagram of a power supply network with an electrical drive system and a device for charging an intermediate circuit capacitor according to one embodiment; and

FIG. 2: a flow chart of a method for charging an intermediate circuit capacitor according to one embodiment.

Unless otherwise stated, identical reference characters refer to identical or functionally identical components shown in the drawings.

### DETAILED DESCRIPTION

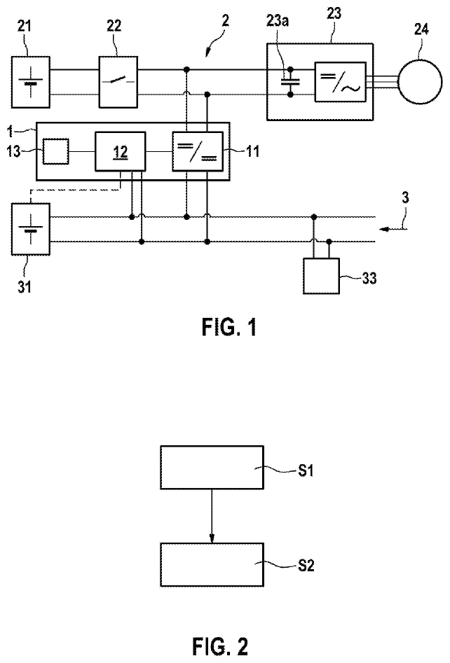

FIG. 1 shows a schematic representation of a power supply network in an electric vehicle with an electrical drive system. The energy supply network comprises a high-voltage network 2 and a low-voltage network 3. The low-voltage network 3 comprises a low-voltage battery 31, which supplies one or multiple electrical consumers 33 in the low-voltage network 3 with electrical energy. For example, the low-voltage network 3 can be a power supply network with an electrical voltage of 12 V, 24 V, or optionally 48 V. The high-voltage network 2 comprises a high-voltage or traction battery 21. This traction battery 21 can, e.g., be connected to the other components of the high-voltage network 2 via a circuit breaker 22. In the deactivated state, the circuit breaker 22 is open so that the traction battery 21 is not electrically connected to the other components of the high-voltage network 2. The other components of the high-voltage network 2 include, in particular, an electrical power converter 23, e.g. an inverter. This power converter 23 can convert the electrical DC voltage provided in the high-voltage network 2 into a single-phase or multi-phase electrical AC voltage and supply this AC voltage to an electrical machine 24. An intermediate circuit capacitor 23a is provided to stabilize the input-side DC voltage in the power converter 23. In the deactivated state, i.e. when the circuit breaker 22 is open, the intermediate circuit capacitor 23a is discharged.

The high-voltage network 2 is coupled to the low-voltage network 3 via a voltage transformer, in particular a DC/DC converter 11. In this way, electrical energy can be transferred from the high-voltage network 2 to the low-voltage network 3 during operation, i.e. when the circuit breaker 22 is closed. In this way, the consumers 33 in the low-voltage network 3 can be supplied with electrical energy. In addition, the battery 31 can also be charged in the low-voltage network 3.

As already explained above, the intermediate circuit capacitor 23a is discharged when the circuit breaker 22 is open. If the circuit breaker 22 is to be closed, the intermediate circuit capacitor 23a must therefore be charged to an electrical voltage that corresponds approximately to the electrical voltage of the traction battery 21 before the circuit breaker 22 is closed. For example, electrical energy can be transferred from the low-voltage network 3 via the DC/DC converter 11 to the high-voltage network and thus to the intermediate circuit capacitor 23a.

Since the intermediate circuit capacitor 23a generally has a relatively high capacitance, a large amount of energy must be drawn from the low-voltage network 3 to charge this intermediate circuit capacitor 23a. If this charging process takes place within a very short period of time, voltage dips of varying severity may occur in the low-voltage network 3. Particularly in the case of a weak, i.e. heavily discharged or possibly heavily aged battery 31 in the low-voltage network 3, charging the intermediate circuit capacitor 23a via the DC/DC converter 11 can lead to a significant voltage dip in the low-voltage network 3.

To avoid excessive voltage dips in the low-voltage network 3 during charging of the intermediate circuit capacitor 23a, the power flow from the low-voltage network 3 to the high-voltage network 2 can be adjusted by a control means 12. Some operating strategies for controlling the power flow from the low-voltage network 3 to the high-voltage network 2 for charging the intermediate circuit capacitor 23a are described below.

The control means 12 can, e.g., determine an electrical voltage in the low-voltage network 3. For example, a simple voltage measurement using a voltage sensor can be provided for this purpose.

Alternatively, the control means 12 can also receive the electrical voltage in the low-voltage network via a data interface or a communication bus from another component that monitors the electrical voltage in the low-voltage network 3. The control means 12 can then adjust the power flow for charging the intermediate circuit capacitor 23a depending on the electrical voltage determined in the low-voltage network 3. For example, a threshold value can be specified. If the electrical voltage in the low-voltage network 3 is above the specified threshold value, the intermediate circuit capacitor 23a is charged with a higher power. If, however, the electrical voltage in the low-voltage network 3 falls below the specified threshold value, the control means 12 sets a lower power flow for charging the intermediate circuit capacitor 23a in the DC/DC converter 11. Of course, a multi-stage approach with more than one threshold value, e.g. two, three or more threshold values, is also possible. In addition, the power flow for charging the intermediate circuit capacitor 23a can also be adjusted linearly between a lower limit voltage and an upper limit voltage as a function of the electrical voltage in the low-voltage network 3. Of course, any other functional relationships between the power flow and the electrical voltage in the low-voltage network 3 are also possible.

In addition to adjusting the power flow to charge the intermediate circuit capacitor 23a, other suitable operating parameters of the low-voltage network 3 can also be considered. For example, a state of charge (SoC), a state of health (SoH) or any other suitable operating parameter of the battery 31 in the low-voltage network 3 can be used to adjust the power flow for charging the intermediate circuit capacitor 23a accordingly. The data of such an operating parameter, in particular of the SoC or SoH, can be received, e.g., by a battery management system of the battery 31 in the low-voltage network 3. Alternatively, any other control component can provide suitable values that are used to control the power flow from the low-voltage network 3 to charge the intermediate circuit capacitor 23a.

For example, the power flow for charging the intermediate circuit capacitor 23a can also be adjusted depending on a temperature, in particular a temperature of the battery 31 in the low-voltage network 3. For example, a lower power flow can be set at a lower temperature, whereas a higher power flow is possible at higher battery temperatures. Any suitable linear or step-by-step controls for adjusting the power flow are also possible here.

In addition to controlling the power flow from the low-voltage network 3 to the intermediate circuit capacitor 23a as a function of a determined operating parameter, it is additionally or alternatively also possible to deactivate one or more consumers 33 in the low-voltage network 3 during charging of the intermediate circuit capacitor 23a or to limit their power consumption. For example, a seat heater or a fan can be switched off or its power consumption reduced while the intermediate circuit capacitor 23a is charging. Of course, any other consumers 33 in the low-voltage network 3 can also be deactivated or their power consumption restricted while the intermediate circuit capacitor 23a is charging. In particular, the power consumption can be deactivated or restricted depending on one of the previously described operating parameters in the low-voltage network 3.

By temporarily deactivating one or multiple consumers 33 in the low-voltage network 3 and controlling the power flow from the low-voltage network 3 to the intermediate circuit capacitor 23a, it is thus possible to charge the intermediate circuit capacitor 23a without excessive voltage dips occurring in the low-voltage network 3 during charging of the intermediate circuit capacitor 23a. In this way, it can be ensured that voltage-sensitive components, such as a control means or similar, are not impaired during charging of the intermediate circuit capacitor 23a.

Furthermore, a signaling device 13 can be provided in the device 1 for charging the intermediate circuit capacitor 23a,
e.g., a display or an acoustic signal transmitter may be provided. Such a component can be used to signal to a user an operating state in the low-voltage network 3 that leads to a reduction in the power flow during charging of the intermediate circuit capacitor 23a. For example, a user can be signaled that the electrical voltage in the low-voltage network 3, a state of charge (SoC) or a state of health (SoH) of the battery 31 in the low-voltage network 3 has reached a critical value. In this way, the user can be informed at an early stage of a potential failure or impairment of the power supply in the low-voltage network 3 so that he can initiate suitable countermeasures in good time. For example, the user can have the battery 31 in the low-voltage center 3 promptly replaced with a new battery.

FIG. 2 shows a flow chart based on a process for charging an intermediate circuit capacitor in a high-voltage network. In principle, the method can comprise any of the steps previously described in connection with the device 1 for charging the intermediate circuit capacitor. Similarly, the device 1 described hereinabove for charging the intermediate circuit capacitor, as well as the described power supply network and the electrical drive system, can also comprise any suitable components as required for implementing the method described below.

In step S1, an operating parameter of the low-voltage network is determined. As previously described hereinabove, the determined operating parameter can be, e.g., an electrical voltage in the low-voltage network, a state of health or state of charge of a battery 31 in the low-voltage network or any other suitable parameter, e.g. a temperature.

In step S2, the intermediate circuit capacitor 23a is then charged in the high-voltage network 2. The intermediate circuit capacitor 23a is in this case charged by means of electrical energy from the low-voltage network 3. In particular, the power flow from the low-voltage network to the intermediate circuit capacitor 23a in the high-voltage network 2 is adjusted, whereby the power flow is adjusted using the determined operating parameter in the low-voltage network.

In summary, the present invention relates to the charging of an intermediate circuit capacitor in a high-voltage network by means of electrical energy from a low-voltage network. It is in this case provided that the power flow from the low-voltage network into the high-voltage network be adjusted using an operating parameter of the low-voltage network, e.g. electrical voltage in the low-voltage network.

1. A device (1) for charging an intermediate circuit capacitor (23a) in a high-voltage network (2), said device comprising:
a DC/DC converter (11) which is configured to be coupled on an input side to a low-voltage network (3) and to be coupled at an output port to the intermediate circuit capacitor (23a) and to provide a charging voltage at the intermediate circuit capacitor (23a) for charging the intermediate circuit capacitor (23a), and
a control means (12) which is configured to determine an operating parameter of the low-voltage network (3) and to adjust a power flow from the low-voltage network (3) to the intermediate circuit capacitor (23a) in the high-voltage network (2) using the determined operating parameter.

2. The device (1) according to claim 1, wherein the control means (12) is configured to determine an electrical voltage of the low-voltage network (3) and to adjust the power flow from the low-voltage network (3) to the intermediate circuit capacitor (23a) in the high-voltage network (2) using the determined electrical voltage of the low-voltage network (3).

3. The device (1) according to claim 1, wherein the control means (12) is configured to determine a status value of a battery (31) connected in the low-voltage network (3) and to adjust the power flow from the low-voltage network (3) to the intermediate circuit capacitor (23a) in the high-voltage network (2) using the determined status value.

4. The device (1) according to claim 1, wherein the control means (12) comprises a data interface configured to receive the operating parameter of the low-voltage network (3).

5. The device (1) according to claim 1, wherein the control means (12) is configured to deactivate at least one consumer (33) connected to the low-voltage network (3) as a function of the determined operating parameter.

6. An energy supply network for an electric vehicle, comprising:
a high-voltage network (2) with a high-voltage battery (21), an intermediate circuit capacitor (23a) and a circuit breaker (22), wherein the circuit breaker (22) is configured to close or open an electrical connection between the high-voltage battery (21) and the intermediate circuit capacitor (23a);
a low-voltage network (3) with a low-voltage battery (31); and
a device (1) for charging the intermediate circuit capacitor (23a) including
a DC/DC converter (11) which is configured to be coupled on an input side to a low-voltage network (3) and to be coupled at an output port to the intermediate circuit capacitor (23a) and to provide a charging voltage at the intermediate circuit capacitor (23a) for charging the intermediate circuit capacitor (23a), and
a control means (12) which is configured to determine an operating parameter of the low-voltage network (3) and to adjust a power flow from the low-voltage network (3) to the intermediate circuit capacitor (23a) in the high-voltage network (2) using the determined operating parameter.

7. An electrical drive system comprising:
a power supply network according to claim 6,
an electric machine (24); and
an electrical power converter (23) configured to control the electrical machine (24) using the electrical energy provided in the high-voltage network (3).

8. A method for charging an intermediate circuit capacitor (23a) in a high-voltage network (2), comprising the following steps:
determining (S1) an operating parameter in a low-voltage network (3);
charging (S2) the intermediate circuit capacitor (23a) in the high-voltage network (2) using electrical energy from the low-voltage network (3), wherein a power flow from the low-voltage network (3) to the intermediate circuit capacitor (23a) in the high-voltage network is set using the determined operating parameter of the low-voltage network (3).

9. The method according to claim 8, comprising a step of deactivating at least one electrical consumer (33) in the low-voltage network (3) during charging of the intermediate circuit capacitor (23a).

10. The method according to claim 8, comprising a step for issuing a warning message if the determined operating parameter of the low-voltage network (3) falls below a predetermined threshold value before and/or during the charging of the intermediate circuit capacitor (23a).
